(19) United States
(12) Patent Application Publication
(10) Pub. No.: US 2017/0332149 A1
(43) Pub. Date: Nov. 16, 2017

(54) TECHNOLOGIES FOR INPUT COMPUTE OFFLOADING OVER A WIRELESS CONNECTION

(71) Applicants: Karthik Veeramani, Hillsboro, OR (US); Paul S. Diefenbaugh, Portland, OR (US); Arvind Kumar, Beaverton, OR (US)

(72) Inventors: Karthik Veeramani, Hillsboro, OR (US); Paul S. Diefenbaugh, Portland, OR (US); Arvind Kumar, Beaverton, OR (US)

(21) Appl. No.: 15/283,346

(22) Filed: Oct. 1, 2016

Related U.S. Application Data
(60) Provisional application No. 62/335,410, filed on May 12, 2016.

(51) Int. Cl. H04N 21/61; H04N 21/462; H04N 21/258

(52) U.S. Cl. CPC H04N 21/6125; H04N 21/25825; H04N 21/462

(57) ABSTRACT

Technologies for input compute offloading of digital content include a source computing device for wirelessly transmitting the digital content to a destination computing device. The destination computing device is configured to detect inputs initiated by a user on a display of the destination computing device and transmit input characteristics to the source computing device that are usable by the source computing device to render the digital content to include one or more objects based on the one or more input characteristics. The source computing device is configured to receive the input characteristics from the destination computing device and render the digital content to include one or more objects based on the one or more input characteristics. Other embodiments are described and claimed.

### CROSS-REFERENCE TO RELATED APPLICATION

The present application claims priority under 35 U.S.C. §119(e) to U.S. Provisional Patent Application Ser. No. 62/335,410, entitled “TECHNOLOGIES FOR INPUT COMPUTE OFFLOADING OVER A WIRELESS CONNECTION,” which was filed on May 12, 2016.

### BACKGROUND

Traditionally, playback of digital content (e.g., movies, music, pictures, games, etc.) has been constrained to the computing device (e.g., desktop computer, smartphone, tablet, wearable, gaming system, television, etc.) on which the digital content was stored. However, with the advent of cloud computing related technologies and increased capabilities of computing devices, services such as digital content streaming, casting, and mirroring have sped up the generation, sharing, and consumption of digital content as consumer devices capable of interacting with such content have become ubiquitous.

To deal with such vast amounts of data transfer in the on-demand landscape, various compression technologies have been implemented to support the streaming of digital content in real-time with reduced latency. Such compression technologies (i.e., codecs and containers) include Moving Picture Experts Group standards (e.g., MPEG-2, MPEG-4, H.264, etc.) and MPEG transport stream (MPEG-TS). Further, various network control protocols, such as real time streaming protocol (RTSP), for example, have been developed for establishing and controlling media sessions between endpoint computing devices. Finally, various transport protocols (e.g., real-time transport protocol (RTP)) usable by the endpoint computing devices have been established for providing end-to-end network transport functions suitable for transmission of the digital content in real-time.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for input compute offloading over a wireless connection;

FIG. 2 is a simplified block diagram of at least one embodiment of an environment of the source computing device of the system of FIG. 1;

FIG. 3 is a simplified block diagram of at least one embodiment of an environment of the destination computing device of the system of FIG. 1;

FIG. 4 is a simplified block diagram of another embodiment of the environment of the source computing device of FIG. 2;

FIG. 5 is a simplified block diagram of another embodiment of the environment of the destination computing device of FIG. 3;

FIG. 6 is a simplified communication flow diagram of at least one embodiment for performing an input compute offloading capability exchange between the source computing device of FIGS. 2 and 4, and the destination computing device of FIGS. 3 and 5;

FIG. 7 is a simplified flow diagram of at least one embodiment for offloading input compute that may be executed by the source computing device of FIGS. 2 and 4; and

FIG. 8 is a simplified flow diagram of at least one embodiment for offloading input compute that may be executed by the destination computing device of FIGS. 3 and 5.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

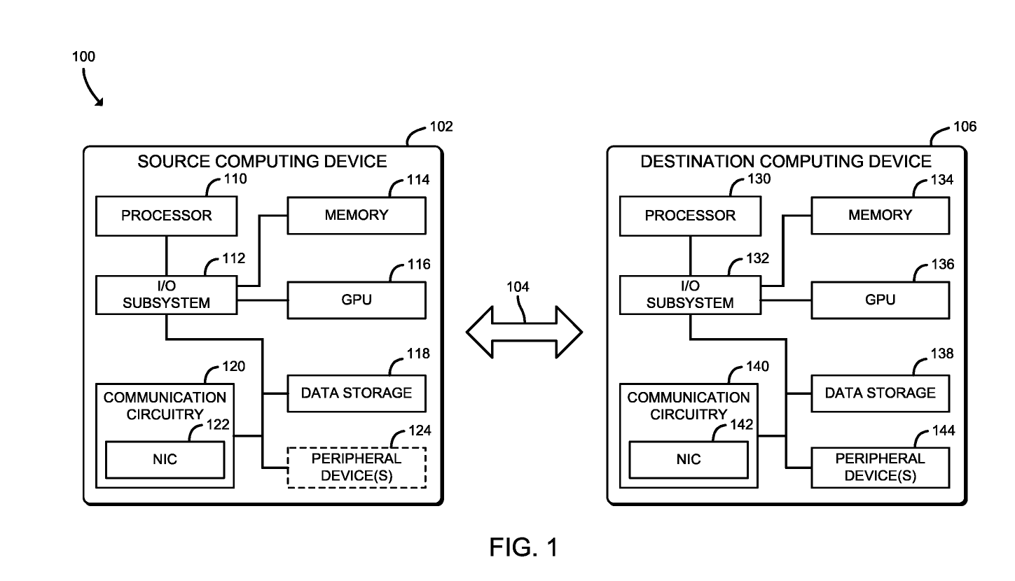

Referring now to FIG. 1, in an illustrative embodiment, a system 100 for transmitting (e.g., streaming, mirroring, casting, etc.) digital content (e.g., video content, audio content, streaming text content, etc.) includes a source computing device 102 communicatively coupled to a destination computing device 106 via a wireless communication channel 104. In use, the source computing device 102 transmits the digital content presently being displayed on, or otherwise presently being processed by, the source computing device 102 to the destination computing device 106 via the wireless communication channel 104. For example, the source computing device 102 may capture images of output presently being rendered on the screen of the source computing device (i.e., a screen capture).

As will be described in further detail, during output (i.e., display) by the destination computing device 106 of digital content received from the source computing device 102, a user of the destination computing device 106 may provide an input to the destination computing device 106 (e.g., via an input device) to initiate an action on an application (e.g., a writing/drawing application) presently executing on the source computing device 102, which is transmitting to the destination computing device 106. During viewing of the digital content, the user may provide an input (e.g., via directly touching or using a stylus on a touchscreen display, pressing a key on a keyboard, moving a controllable element of a mouse, speaking an audible voice command captured by a microphone, etc.) to the destination computing device 106 in which an outcome of the input is expected.

For example, the expected outcome may be to render one or more objects (e.g., text, shapes, lines, graphics, etc.) on the display of the destination computing device 106 based on the detected local input. In an illustrative example, the user may draw or otherwise insert an object on a display (e.g., a touchscreen display) of the destination computing device 106 while the destination computing device 106 is displaying the digital content received from the source computing device 102 with the expectation that the destination computing device 106 is to display the object. In another illustrative example, the user may change a setting of an application presently executing on the source computing device 102 that is viewable on the display of the destination computing device 106. Under such conditions, the destination computing device 106 is configured to temporarily render the detected local input using one or more objects to allow the user to view/change the setting(s) and transmit one or more characteristics of the detected input to the source computing device 102. The input characteristics may include any data usable by the source computing device 102 to identify a location of the input relative to the location of the displayed image on the destination computing device 106, as well as any data usable to render the desired output at the corresponding location. Such input characteristics may include coordinates (e.g., screen/display coordinates, output content coordinates, input border coordinates, etc.), an input type (e.g., text, a shape, a graphic, etc.), font/line characteristics (e.g., types, styles, sizes, colors, weights, etc.), etc.

The source computing device 102 is configured to identify the received input characteristics and render the inputs on the display of the source computing device 102. The source computing device 102 is further configured to transmit the updated digital content. The source computing device 102 may additionally be configured to provide an indication to the destination computing device 106 indicating the digital content has been updated to include the input. Accordingly, upon receipt of the updated digital content or the indication, the destination computing device 106 can discontinue rendering the temporary overlay and output the updated digital content received from the source computing device 102. In other words, the destination computing device 106 can just display the received digital content that has been updated to include the input previously transmitted from the destination computing device 106.

It should be appreciated that the transmitting of digital content discussed herein is applicable to different types of transmission including, but not limited to, streaming of digital content, mirroring of digital content, and casting of digital content. As such, although the term “stream” or “streaming” may be used at times to describe a particular type of transmission, it should be appreciated that the corresponding transmission may be effected by mirroring, casting, or otherwise transmitting using another transmission modality. In typical streaming transmissions, the digital content is progressively transferred. For example, instead of downloading or retrieving the full digital content, a client device (e.g., the destination computing device 106) may actively play a portion of the digital content while downloading or retrieving other parts of the digital content. In typical mirroring transmissions, a source device shares its screen (or content that would be displayed on its screen) with a destination device. The digital content transmission during a mirroring session may use a progressive transfer or non-progressive data transfer (e.g., the digital content may be downloaded completely). In typical casting transmissions, a source device shares content with a destination device. The digital content transmission during a casting session may use a progressive transfer or non-progressive data transfer. Additionally, in some implementations, the source device may transmit a link or other location-indicator to digital content, which is subsequently retrieved by the destination device form a source different from the source device. (e.g., the digital content may be downloaded completely).

It should be further appreciated that, while the context of the present disclosure is described below as receiving input from a user (e.g., via directly touching or using a stylus on a touchscreen display, pressing a key on a keyboard, detecting movement of an element of a mouse, receiving an audible voice command by a microphone, etc.) to a display of the destination computing device 106, such functionality described herein may be usable for other forms of detected input that is capable of being characterized and rendered as described herein.

The source computing device 102 may be embodied as any type of computing device that is capable of performing the functions described herein, such as, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, a multiprocessor system, a set-top box, and/or any other computing/communication device capable of performing the functions described herein.

The illustrative source computing device 102 includes a processor (i.e., a CPU) 110, an input/output (I/O) subsystem 112, a memory 114, a graphics processing unit (GPU) 116, a data storage device 118, and communication circuitry 120, as well as, in some embodiments, one or more peripheral devices 124. Of course, the source computing device 102 may include other or additional components in other embodiments, such as those commonly found in a computing device. Additionally, in some embodiments, one or more of the illustrative components may be incorporated in, or otherwise form a portion of, another component. For example, in some embodiments, the memory 114, or portions thereof, may be incorporated in the processor 110. Further, in some embodiments, one or more of the illustrative components may be omitted from the source computing device 102.

The processor 110 may be embodied as any type of processor capable of performing the functions described herein. Accordingly, the processor 110 may be embodied as a single or multi-core processor(s), digital signal processor, microcontroller, or other processor or processing/controlling circuit. The memory 114 may be embodied as any type of volatile or non-volatile memory or data storage capable of performing the functions described herein. In operation, the memory 114 may store various data and software used during operation of the source computing device 102, such as operating systems, applications, programs, libraries, and drivers.

The memory 114 is communicatively coupled to the processor 110 via the I/O subsystem 112, which may be embodied as circuitry and/or components to facilitate input/output operations with the processor 110, the memory 114, and the GPU 116, as well as other components of the source computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the source computing device 102, on a single integrated circuit chip.

The GPU 116 may be embodied as circuitry and/or components to handle specific types of tasks assigned to the GPU 116, such as image rendering, for example. To do so, the GPU 116 may include an array of processor cores or parallel processors (not shown), each of which can execute a number of parallel and concurrent threads. In some embodiments, the processor cores of the GPU 116 may be configured to individually handle 3D rendering tasks, blitter (e.g., 2D graphics), and/or video encoding/decoding tasks, by providing electronic circuitry that can perform mathematical operations rapidly using extensive parallelism and multiple concurrent threads. It should be appreciated that, in some embodiments, the GPU 116 may have direct access to the memory 114, thereby allowing direct memory access (DMA) functionality in such embodiments.

The data storage device 118 may be embodied as any type of device or devices configured for short-term or long-term storage of data such as, for example, memory devices and circuits, memory cards, hard disk drives, solid-state drives, or other data storage devices. It should be appreciated that the data storage device 118 and/or the memory 114 (e.g., the computer-readable storage media) may store various data as described herein, including operating systems, applications, programs, libraries, drivers, instructions, etc., capable of being executed by a processor (e.g., the processor 110) of the source computing device 102.

The communication circuitry 120 may be embodied as any communication circuit, device, or collection thereof, capable of enabling communications between the source computing device 102 and other computing devices (e.g., the destination computing device 106 and/or other computing devices communicatively coupled to the source computing device 102) over a wired or wireless communication channel (e.g., the wireless communication channel 104). The communication circuitry 120 may be configured to use any one or more wired or wireless communication technologies and associated protocols (e.g., Ethernet, Wi-Fi®, Wi-Fi Direct®, Bluetooth®, Bluetooth® Low Energy (BLE), near-field communication (NFC), Worldwide Interoperability for Microwave Access (WiMAX), etc.) and/or certified technologies (e.g., Digital Living Network Alliance (DLNA), Miracast™, etc.) to affect such communication. The communication circuitry 120 may be additionally configured to use any one or more wireless and/or wired communication technologies and associated protocols to effect communication with other computing devices, such as over a network, for example.

The illustrative communication circuitry 120 includes a network interface controller (NIC) 122. The NIC 122 may be embodied as one or more add-in-boards, daughtercards, network interface cards, controller chips, chipsets, or other devices that may be used by the source computing device 102. In some embodiments, for example, the NIC 122 may be integrated with the processor 110, embodied as an expansion card coupled to the I/O subsystem 112 over an expansion bus (e.g., PCI Express), included as a part of a SoC that includes one or more processors, or included on a multichip package that also contains one or more processors.

The peripheral devices 124 may include any number of I/O devices, interface devices, and/or other peripheral devices. For example, in some embodiments, the peripheral devices 124 may include a display, a touch screen, graphics circuitry, a keyboard, a mouse, a microphone, a speaker, and/or other input/output devices, interface devices, and/or peripheral devices. The particular devices included in the peripheral devices 124 may depend on, for example, the type and/or intended use of the source computing device 102. The peripheral devices 124 may additionally or alternatively include one or more ports, such as a universal serial bus (USB) port, a high-definition multimedia interface (HDMI) port, etc., for connecting external peripheral devices to the source computing device 102.

In the illustrative embodiment, the wireless communication channel 104 is embodied as a direct line of communication (i.e., no wireless access point) between the source computing device 102 and the destination computing device 106. For example, the wireless communication channel 104 may be established over an ad hoc peer-to-peer connection, such as Wi-Fi Direct®, Intel® Wireless Display (WiDi), Bluetooth®, etc., using a wireless display standard (e.g., AirPlay®, Miracast™, DLNA, etc.) Alternatively, in some embodiments, the wireless communication channel 104 may be embodied as any type of wireless communication network, including a wireless local area network (WLAN), a wireless personal area network (WPAN), a cellular network (e.g., Global System for Mobile Communications (GSM), Long-Term Evolution (LTE), etc.), or any combination thereof. It should be appreciated that, in such embodiments, the wireless communication channel 104 may serve as a centralized network and, in some embodiments, may be communicatively coupled to another network (e.g., the Internet). Accordingly, in such embodiments, the wireless communication channel 104 may include a variety of virtual and/or physical network devices (not shown), such as routers, switches, network hubs, servers, storage devices, compute devices, etc., as needed to facilitate the transfer of data between the source computing device 102 and the destination computing device 106.

The destination computing device 106 may be embodied as any type of computation or computing device capable of performing the functions described herein, including, without limitation, a computer, a portable computing device (e.g., smartphone, tablet, laptop, notebook, wearable, etc.), a “smart” television, a cast hub, a cast dongle, a processor-based system, and/or a multiprocessor system. Similar to the illustrative source computing device 102, the destination computing device 106 includes a processor 130, an I/O subsystem 132, a memory 134, a GPU 136, a data storage device 138, communication circuitry 140 that includes a NIC 142, and one or more peripheral devices 144. As such, further descriptions of the like components are not repeated herein with the understanding that the description of the corresponding components provided above in regard to the source computing device 102 applies equally to the corresponding components of the destination computing device 106.

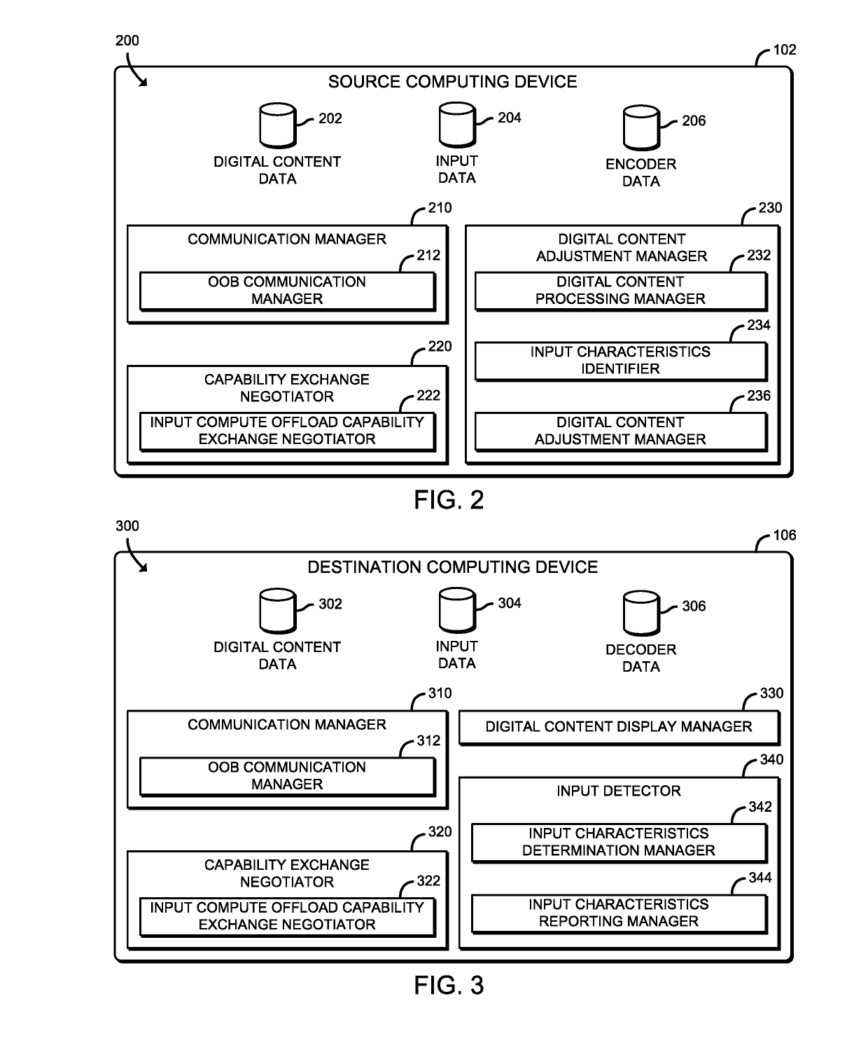

Referring now to FIG. 2, in an illustrative embodiment, the source computing device 102 establishes an environment 200 during operation. The illustrative environment 200 includes a communication manager 210, a capability exchange negotiator 220, and a digital content adjustment manager 230. The various components of the environment 200 may be embodied as hardware, firmware, software, or a combination thereof. Additionally, in some embodiments, one or more of the illustrative components may form a portion of another component and/or one or more of the illustrative components may be independent of one another. Further, in some embodiments, one or more of the components of the environment 200 may be embodied as virtualized hardware components or emulated architecture, which may be established and maintained by the one or more processors and/or other hardware components of the source computing device 102.

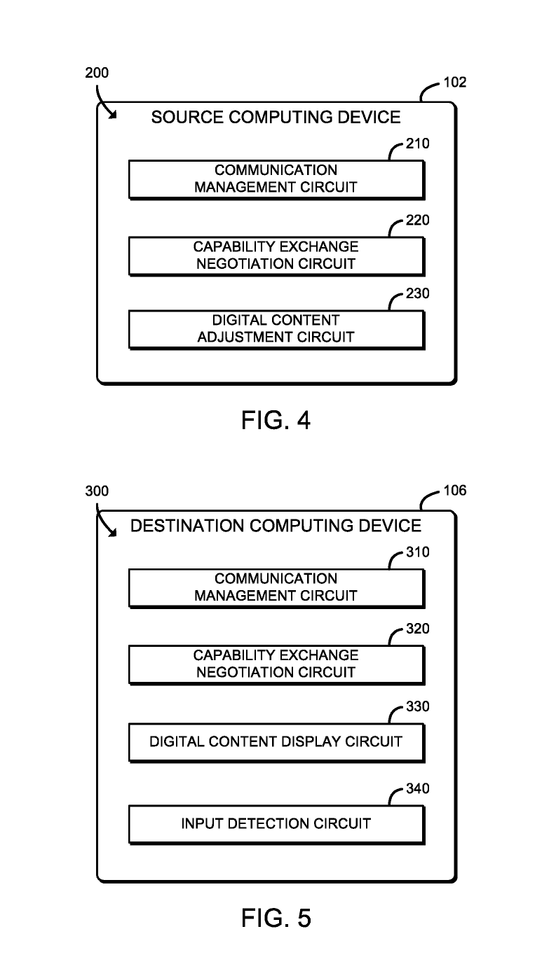

In an illustrative embodiment, as shown in FIG. 4, the environment 200 may include a communication management circuit 210, a capability exchange negotiation circuit 220, and a digital content adjustment circuit 230. In such embodiments, each circuit 210, 220, 230 may be embodied as a dedicated circuit/hardware component or be embodied as a portion of another hardware component of the source computing device 102. For example, in some embodiments, one or more of the communication management circuit 210, the capability exchange negotiation circuit 220, and the digital content adjustment circuit 230 may form a portion of the one or more of the processor 110, the I/O subsystem 112, the GPU 116, the communication circuitry 120, and/or other components of the source computing device 102.

Additionally or alternatively, one or more of the communication management circuit 210, the capability exchange negotiation circuit 220, and/or the digital content adjustment circuit 230 may be implemented as special purpose hardware circuits or components. Such dedicated or special purpose hardware circuits or logic may complement certain software functions, which may facilitate the calling of such functions by various software programs or applications executed by the source computing device 102 to complete one or more tasks. It should be appreciated that the source computing device 102 may include other components, sub-components, modules, sub-modules, logic, sub-logic, and/or devices commonly found in a computing device, which are not illustrated in FIG. 2 for clarity of the description.

In the illustrative environment 200, the source computing device 102 further includes digital content data 202, input data 204, and encoder data 206, each of which may be stored in a memory and/or data storage device of the source computing device 102. Further, each of the digital content data 202, the input data 204, and the encoder data 206 may be accessed by the various components of the source computing device 102. Additionally, it should be appreciated that in some embodiments the data stored in, or otherwise represented by, each of the digital content data 202, the input data 204, and/or the encoder data 206 may not be mutually exclusive relative to each other. For example, in some implementations, data stored in the digital content data 202 may also be stored as a portion of one or more of the input data 204 and the encoder data 206, or vice versa. As such, although the various data utilized by the source computing device 102 is described herein as particular discrete data, such data may be combined, aggregated, and/or otherwise form portions of a single or multiple data sets, including duplicative copies, in other embodiments.

The communication manager 210, which may be embodied as hardware, firmware, software, virtualized hardware, emulated architecture, and/or a combination thereof as discussed above, is configured to manage (e.g., setup, maintain, etc.) connection paths between the source computing device 102 and other computing devices (e.g., the destination computing device 106). Additionally, the communication manager 210 is configured to facilitate inbound and outbound wired and/or wireless communications (e.g., network traffic, network packets, network flows, etc.) to and from the source computing device 102.

To do so, the communication manager 210 is configured to receive and process network packets from other computing devices (e.g., the destination computing device 106 and/or other computing device(s) communicatively coupled to the source computing device 102). Additionally, the communication manager 210 is configured to prepare and transmit network packets to another computing device (e.g., the destination computing device 106 and/or other computing device(s) communicatively coupled to the source computing device 102). The illustrative communication manager 210 includes an out-of-band communication manager 212 configured to manage out-of-band communication data flows across out-of-band communication channels (e.g., NFC, USB, etc.), such as may be used to transmit/receive the input characteristic data described herein.

The capability exchange negotiator 220, which may be embodied as hardware, firmware, software, virtualized hardware, emulated architecture, and/or a combination thereof as discussed above, is configured to perform the capability exchange negotiations between the source computing device 102 and other computing devices (e.g., the destination computing device 106). It should be appreciated that the capability exchange negotiator 220 may be configured to perform the capability exchange during setup of the wireless communication channel 104.

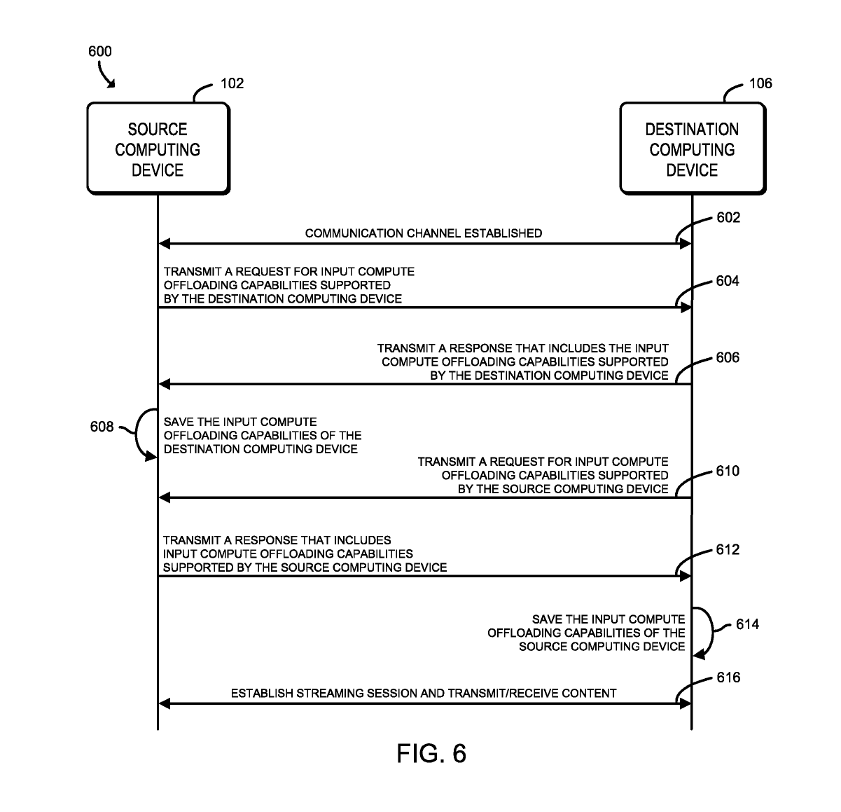

The illustrative capability exchange negotiator 220 includes an input compute offload exchange negotiator 222 that is configured to determine whether the destination computing device 106 supports input compute offloading (see also, e.g., the communication flow 600 of FIG. 6 described below). In other words, the input compute offload exchange negotiator 222 is configured to perform a capability exchange with the destination computing device 106 to determine whether the destination computing device 106 supports input compute offloading (i.e., can detect user inputs and translate the detected inputs into input characteristics translatable by the source computing device 102), such as may be included in a particular header field or payload of the network packets transmitted from the destination computing device 106. For example, an input compute offload capability indicator may be any type of data that indicates whether the respective computing device is configured to support input compute offload capability, such as a Boolean value, for example. In such an embodiment, a not supported value, or value of “0”, may be used to indicate that input compute offload capability is not supported and a supported value, or value of “1”, may be used to indicate that input compute offload capability is supported.

For example, in an embodiment using the RTSP protocol to exchange computing device capabilities, the input compute offload capability indicator may be associated with an RTSP parameter (e.g., an “input compute offload support” parameter) to be sent with a request message from the source computing device 102 and received with a response from the destination computing device 106 during initial configuration (i.e., negotiation and exchange of various parameters) of a communication channel (e.g., the wireless communication channel 104 of FIG. 1) between the source computing device 102 and the destination computing device 106. In some embodiments, whether the source computing device 102 supports input compute offloading, which inputs (i.e., input characteristics) are supported by the source computing device 102, whether the destination computing device 106 supports input compute offloading, and/or which inputs are supported by the destination computing device 106 may be stored in the input data 204.

It should also be appreciated that, in some embodiments, one or both of the source computing device 102 and the destination computing device 106 may support more than one set of input characteristics. In such embodiments, the capability exchange may further include a negotiation between the source computing device 102 and the destination computing device 106 to negotiate which input characteristics are supported and which of the supported input characteristics are to be used during a particular digital content transmission session. Accordingly, in such embodiments, the supported input characteristics (e.g., of the source computing device 102 and/or the destination computing device 106) and/or which of the supported input characteristics are determined to be used during the particular streaming session may be stored in the input data 204.

The digital content adjustment manager 230, which may be embodied as hardware, firmware, software, virtualized hardware, emulated architecture, and/or a combination thereof as discussed above, is configured to output digital content from the source computing device 102 to a communicatively coupled destination computing device 106. To do so, the illustrative digital content adjustment manager 230 includes a digital content processing manager 232, an input characteristics identifier 234, and a digital content adjustment manager 236. It should be appreciated that each of the digital content processing manager 232, the input characteristics identifier 234, and/or the digital content adjustment manager 236 of the streaming packet manager 230 may be separately embodied as hardware, firmware, software, virtualized hardware, emulated architecture, and/or a combination thereof. For example, the digital content processing manager 232 may be embodied as a hardware component, while the input characteristics identifier 234 and/or the digital content adjustment manager 236 is embodied as a virtualized hardware component or as some other combination of hardware, firmware, software, virtualized hardware, emulated architecture, and/or a combination thereof.

The digital content processing manager 232 is configured to encode a frame of digital content (i.e., using an encoder of the source computing device 102) to be transmitted to the destination computing device 106 for display on the destination computing device 106. In some embodiments, the digital content to be streamed may be stored in the digital content data 202. Additionally or alternatively, in some embodiments, information associated with the encoder (e.g., which encoders/decoders are supported by the source computing device 102 and/or the destination computing device 106) may be stored in the encoder data 206. It should be appreciated that data of a frame of digital content may have a size that is too large to attach as a single payload of a network packet based on transmission size restrictions of the source computing device 102 and/or the destination computing device 106. For example, the frame size may be larger than a predetermined maximum transmission unit.

Accordingly, the digital content processing manager 232 (e.g., a packetizer of the source computing device 102) is configured to packetize the frame (i.e., the encoded frame) into a plurality of chunks, the total of which may be determined by a function of a total size of the frame and the predetermined maximum transmission unit size. Additionally, the digital content processing manager 232 is configured to attach a header including identifying information to each of the chunks, forming a sequence of network packets for transmission to the destination computing device 106. Such packetization results in a first network packet that includes the first chunk of data, a number of intermediate network packets that include the intermediate chunks of frame data, and a last network packet that includes the last chunk of frame data required to be received by the destination computing device 106 (i.e., the end of the frame) before the destination computing device 106 can decode the frame based on the received chunks of the frame. The input characteristics identifier 234 is configured to identify input characteristics received from the destination computing device 106 and the digital content adjustment manager 236 is configured to adjust the digital content based on the identified input characteristics.

Referring now to FIG. 3, in an illustrative embodiment, the destination computing device 106 establishes an environment 300 during operation. The illustrative environment 300 includes a communication manager 310, a capability exchange negotiator 320, a digital content display manager 330, and an input detector 340. The various components of the environment 300 may be embodied as hardware, firmware, software, or a combination thereof. Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the one or more processors and/or other hardware components of the source computing device 102.

In an illustrative embodiment, as shown in FIG. 5, one or more of the components of the environment 300 may be embodied as circuitry, physical hardware components, and/or a collection of electrical devices. For example, as shown, the environment 300 may include a communication management circuit 310, a capability exchange negotiation circuit 320, a digital content display circuit 330, and/or an input detection circuit 340. In such embodiments, each circuit 310, 320, 330, 340 may be embodied as a dedicated circuit/hardware component or be embodied as a portion of another hardware component of the source computing device 102. For example, in some embodiments, one or more of the communication management circuit 310, the capability exchange negotiation circuit 320, the digital content display circuit 330, and the input detection circuit 340 may form a portion of the one or more of the processor 130, the I/O subsystem 132, the GPU 136, the communication circuitry 140, and/or other components of the destination computing device 106.

Additionally or alternatively, one or more of the communication management circuit 310, the capability exchange negotiation circuit 320, the digital content display circuit 330, and/or the input detection circuit 340 may be implemented as special purpose hardware circuits or components. Such dedicated or special purpose hardware circuits or logic may complement certain software functions, which may facilitate the calling of such functions by various software programs or applications executed by the destination computing device 106 to complete one or more tasks.

Referring again to FIG. 3, in the illustrative environment 300, the destination computing device 106 further includes digital content data 302, input data 304, and decoder data 306, each of which may be stored in a memory and/or data storage device of the destination computing device 106. Further, each of the digital content data 302, the input data 304, and the decoder data 306 may be accessed by the various components of the destination computing device 106. Additionally, it should be appreciated that in some embodiments the data stored in, or otherwise represented by, each of the digital content data 302, the input data 304, and/or the decoder data 306 may not be mutually exclusive relative to each other.

For example, in some implementations, data stored in the digital content data 302 may also be stored as a portion of one or more of the input data 304 and the decoder data 306, or vice versa. As such, although the various data utilized by the destination computing device 106 is described herein as particular discrete data, such data may be combined, aggregated, and/or otherwise form portions of a single or multiple data sets, including duplicative copies, in other embodiments. It should be further appreciated that the destination computing device 106 may include additional and/or alternative components, sub-components, modules, sub-modules, and/or devices commonly found in a computing device, which are not illustrated in FIG. 3 for clarity of the description.

The communication manager 310, which may be embodied as hardware, firmware, software, virtualized hardware, emulated architecture, and/or a combination thereof as discussed above, is configured to manage (e.g., setup, maintain, etc.) connection paths between the source computing device 102 and other computing devices (e.g., the destination computing device 106). Additionally, the communication manager 310 is configured to facilitate inbound and outbound wired and/or wireless communications (e.g., network traffic, network packets, network flows, etc.) to and from the source computing device 102.

To do so, the communication manager 310 is configured to receive and process network packets from other computing devices (e.g., the destination computing device 106 and/or other computing device(s) communicatively coupled to the destination computing device 106). Additionally, the communication manager 310 is configured to prepare and transmit network packets to another computing device (e.g., the source computing device 102 and/or other computing device(s) communicatively coupled to the destination computing device 106). The illustrative communication manager 310 includes an out-of-band communication manager 312 configured to manage out-of-band communication data flows across out-of-band communication channels (e.g., as may be managed by the capability exchange negotiator 320), such as may be used to transmit/receive the input characteristic data described herein.

The capability exchange negotiator 320, which may be embodied as hardware, firmware, software, virtualized hardware, emulated architecture, and/or a combination thereof as discussed above, is configured to perform the capability exchange negotiations between the destination computing device 106 and other computing devices (e.g., the source computing device 102). It should be appreciated that the capability exchange negotiator 320 may be configured to perform the capability exchange during setup of the wireless communication channel 104.

The illustrative capability exchange negotiator 320 includes an input compute offload exchange negotiator 322 that is configured to determine whether the source computing device 102 supports input compute offloading (see also, e.g., the communication flow 600 of FIG. 6 described below). In other words, the input compute offload exchange negotiator 320 is configured to perform a capability exchange with the source computing device 102 to determine whether the source computing device 102 supports input compute offloading (i.e., can translate input characteristics received from the source computing device 102), such as may be included in a particular header field or payload of the network packets transmitted to the source computing device 102. For example, an input compute offload capability indicator may be any type of data that indicates whether the respective computing device is configured to support input compute offload capability, such as a Boolean value, for example. In such an embodiment, a not supported value, or value of “0”, may be used to indicate that input compute offload capability is not supported and a supported value, or value of “1”, may be used to indicate that input compute offload capability is supported.

For example, in an embodiment using the RTSP protocol to exchange computing device capabilities, the input compute offload capability indicator may be associated with an RTSP parameter (e.g., an “input compute offload support” parameter) received with a request message from the source computing device 102 and sent with a response from the destination computing device 106 during initial configuration (i.e., negotiation and exchange of various parameters) of a communication channel (e.g., the wireless communication channel 104 of FIG. 1) between the source computing device 102 and the destination computing device 106. In some embodiments, whether the source computing device 102 supports input compute offloading, which inputs (i.e., input characteristics) are supported by the source computing device 102, whether the destination computing device 106 supports input compute offloading, and/or which inputs are supported by the destination computing device 106 may be stored in the input data 204.

It should also be appreciated that, in some embodiments, one or both of the source computing device 102 and the destination computing device 106 may support more than one set of input characteristics. In such embodiments, the capability exchange may further include a negotiation between the source computing device 102 and the destination computing device 106 to negotiate which input characteristics are supported and which of the supported input characteristics are to be used during a particular digital content transmission session. Accordingly, in such embodiments, the supported input characteristics (e.g., of the source computing device 102 and/or the destination computing device 106) and/or which of the supported input characteristics are determined to be used during the particular streaming session may be stored in the input data 204.

The digital content display manager 330, which may be embodied as hardware, firmware, software, virtualized hardware, emulated architecture, and/or a combination thereof as discussed above, is configured to display digital content received from the communicatively coupled source computing device 102. To do so, the digital content display manager 330 is configured to depacketize received network packets (i.e., one or more network packets including at least a portion of data corresponding to a frame). For example, the digital content display manager 330 may be configured to strip the headers (i.e., the MPEG2-TS headers) from the received network packets and accumulate the payloads of the received frames of digital content. Such accumulated payloads may be stored in the digital content data 304, in some embodiments.

Accordingly, the digital content display manager 330 is further configured to decode the accumulated payloads (i.e., at the GPU 136 of the destination computing device 106 of FIG. 1) and render the decoded frame for output at an output device (e.g., a display) of the destination computing device 106. In some embodiments, information associated with the decoder (e.g., which encoders/decoders are supported by the source computing device 102 and/or the destination computing device 106) may be stored in the decoder data 306. Additionally or alternatively, in some embodiments, information corresponding to the decoded frame may be stored in the digital content data 302.

The input detector 340 is configured to detect input of a user of the destination computing device 106, such as may be initiated via directly touching or using a stylus on a touchscreen display, pressing a key on a keyboard, detecting movement of an element of a mouse, receiving an audible voice command by a microphone, etc. The detected input may be of any type of input in which the expected outcome of the input is to render one or more objects (e.g., text, shapes, lines, graphics, etc.) on the display of the destination computing device 106. The illustrative input detector 340 includes an input characteristics determination manager 342 configured to determine input characteristics of the detected input and an input characteristics reporting manager 344 configured to translate the determined input characteristics into information (i.e., data structures) usable by the source computing device 102 to replicate the detected input.

Referring now to FIG. 6, an embodiment of a communication flow 600 for input compute offloading capability negotiation includes the source computing device 102 and the destination computing device 106 communicatively coupled over a communication channel (e.g., the communication channel 104 of FIG. 1). The illustrative communication flow 600 includes a number of data flows, some of which may be executed separately or together, depending on the embodiment. In data flow 602, as described previously, the communication channel 104 (e.g., a TCP connection) is established between the source computing device 102 and the destination computing device 106. It should be appreciated that the establishment of the communication channel may be predicated on a distance between the source computing device 102 and the destination computing device 106. It should be further appreciated that the distance may be based on a type and communication range associated with the communication technology employed in establishing the communication channel 104.

In some embodiments, the source computing device 102 and the destination computing device 106 may have been previously connected to each other. In other words, the source computing device 102 and the destination computing device 106 may have previously exchanged pairing data, such as may be exchanged during a Wi-Fi® setup (e.g., manual entry of connection data, Wi-Fi Protected Setup (WPS), etc.) or Bluetooth® pairing (e.g., bonding). To do so, in some embodiments, the source computing device 102 or the destination computing device 106 may have been placed in a discovery mode for establishing the connection. Additionally or alternatively, in some embodiments, the source computing device 102 and the destination computing device 106 may use an out-of-band technology (e.g., NFC, USB, etc.) to transfer information by a channel other than the communication channel 104. Accordingly, it should be appreciated that, in such embodiments, the information used to establish the communication channel 104, or the 00B channel, may be stored at the source computing device 102 and/or the destination computing device 106.

In data flow 604, the source computing device 102 transmits a message to the destination computing device 106 (e.g., using RTSP messages) that includes a request for input compute offloading detection capability of the destination computing device 106. In data flow 606, the destination computing device 106 responds to the request message received from the source computing device with a response message that includes the input compute offloading capability of the destination computing device 106. In data flow 608, the source computing device 102 saves the input compute offloading capability of the destination computing device 106 received in data flow 606.

It should be appreciated that, in some embodiments, more than one input compute offloading capability may be supported by the source computing device 102 and/or the destination computing device 106. Accordingly, as described previously, the input compute offloading capability response may include an indication as to whether the destination computing device 106 supports certain input characteristics of input compute offloading, as well as an indication as to how the destination computing device 106 supports, translates, transmits, etc. such input characteristics (e.g., a particular field of a header message, a particular designator in a payload of a message, etc.). In such embodiments, a negotiation flow may be performed between the source computing device 102 and the destination computing device 106 to establish which of the supported input compute offloading capabilities will be used during the streaming session.

In data flow 610, the destination computing device 106 transmits a message to the source computing device 102 that includes a request for input compute offloading capability of the source computing device 102. In data flow 612, the source computing device 102 responds to the request message with a response message that includes the input compute offloading capability of the source computing device 102. In data flow 614, the destination computing device 106 saves the input compute offloading capability of the source computing device 102 received in data flow 612. In data flow 616, the source computing device 102 and the destination computing device 106 establish a streaming session and initiate the transmission/receipt of digital content.

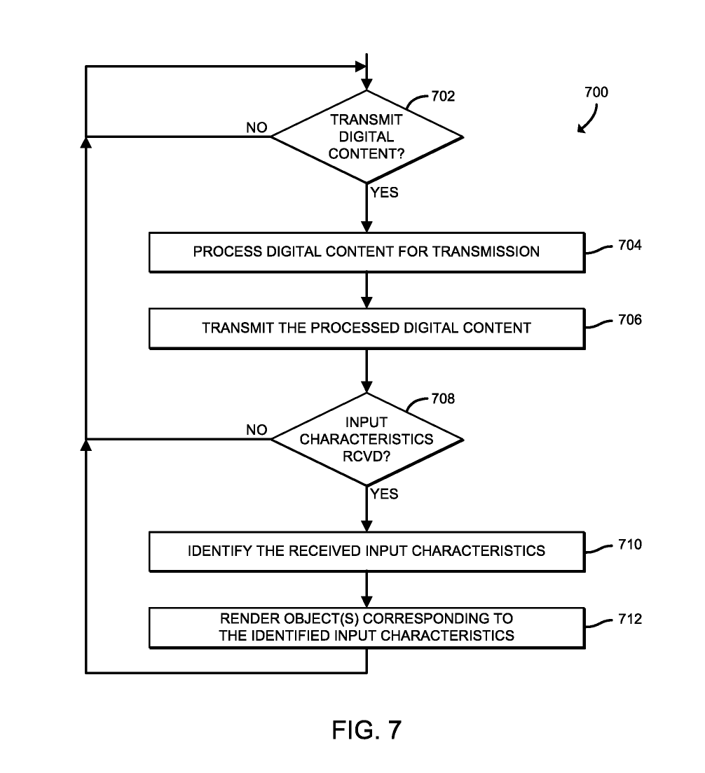

Referring now to FIG. 7, in use, the source computing device 102 may execute a method 700 for input compute offloading of digital content to be transmitted to a destination computing device (e.g., the destination computing device 106 of FIG. 1). It should be appreciated that prior to execution of the method 700, a communication channel (e.g., the communication channel 104 of FIG. 1) has already been established and capabilities have been exchanged between the source computing device 102 and the destination computing device 106 (e.g., as described in the illustrative communication flow 600 of FIG. 6). It should be further appreciated that at least a portion of method 700 may be embodied as various instructions stored on a computer-readable media, which may be executed by the processor 110, the GPU 116, the communication circuitry 120 (e.g., the NIC 122), and/or other components of the source computing device 102 to cause the source computing device 102 to perform the method 600. The computer-readable media may be embodied as any type of media capable of being read by the source computing device 102 including, but not limited to, the memory 114, the data storage device 118, a local memory (not shown) of the NIC 122, other memory or data storage devices of the source computing device 102, portable media readable by a peripheral device of the source computing device 102, and/or other media.

The method 700 begins in block 702, in which the source computing device 102 determines whether to transmit digital content to the destination computing device 106 (e.g., streaming content from the source computing device, mirroring content presently being displayed on the source computing device 102, casting content from the source computing device, etc.). If the source computing device 102 determines not to transmit digital content to the destination computing device 106 (e.g., digital content stored on the source computing device 102 has not yet been selected for transmission), the method 700 returns to block 702 to continue to monitor whether to transmit the digital content. It should be appreciated that in some embodiments any applications (e.g., operating system, software applications, etc.) presently being displayed (e.g., via a graphical user interface (GUI) of the source computing device 102) may be transmitted to the destination computing device 106 in the form of digital content (e.g., frames of the presently displayed screen of the source computing device 102)

Otherwise, the method 700 advances to block 704, in which the source computing device 102 processes digital content for transmission to the destination computing device 106. For example, the source computing device 102 may encode the digital content (i.e., the frames of the digital content), such as by using an RTSP encoder, and packetize the encoded frame into a streaming packet for transmission (e.g., chunking the frame and affixing each chunk as a streaming packet payload with a header). In block 706, the source computing device 102 transmits one or more of the processed streaming packets to the destination computing device 106 (e.g., via a queue of network packets, messages, etc.). As discussed above, in other embodiments, the source computing device 102 may transmit the digital content using other transmission modalities including, but not limited to, mirroring of the digital content, casting of the digital content, and/or other digital content transmission technique.

In block 708, the source computing device 102 determines whether any input characteristics have been received from the destination computing device 106. If not, the method 700 loops back to block 702 to determine whether to continue transmitting digital content to the destination computing device 106; otherwise, the method 700 advances to block 710. In some embodiments, the operating system of the source computing device 102 may receive the indication from the destination computing device 106 and subsequently notify any listening application of the received input characteristics using the same or similar notification methodologies as the destination computing device 106 would use to notify any listening application of an input detected local to the source computing device 102.

In block 710, the source computing device 102 identifies the input characteristics received from the destination computing device 106. In block 712, the source computing device 102 renders one or more objects to a display (e.g., via the GPU 116 of FIG. 1) based on the input characteristics for output to a display of the source computing device 102. For example, the source computing device 102 may capture an image of the content presently displayed on the display of the source computing device 102 (i.e., including the rendered output of the input characteristics). In some embodiments, the captured image may be compressed as a video stream and transmitted to the destination computing device 106. In some embodiments, the source computing device 102 may additionally transmit an indication to the destination computing device 102 that is usable to identify that the received digital content now includes the received input characteristics.

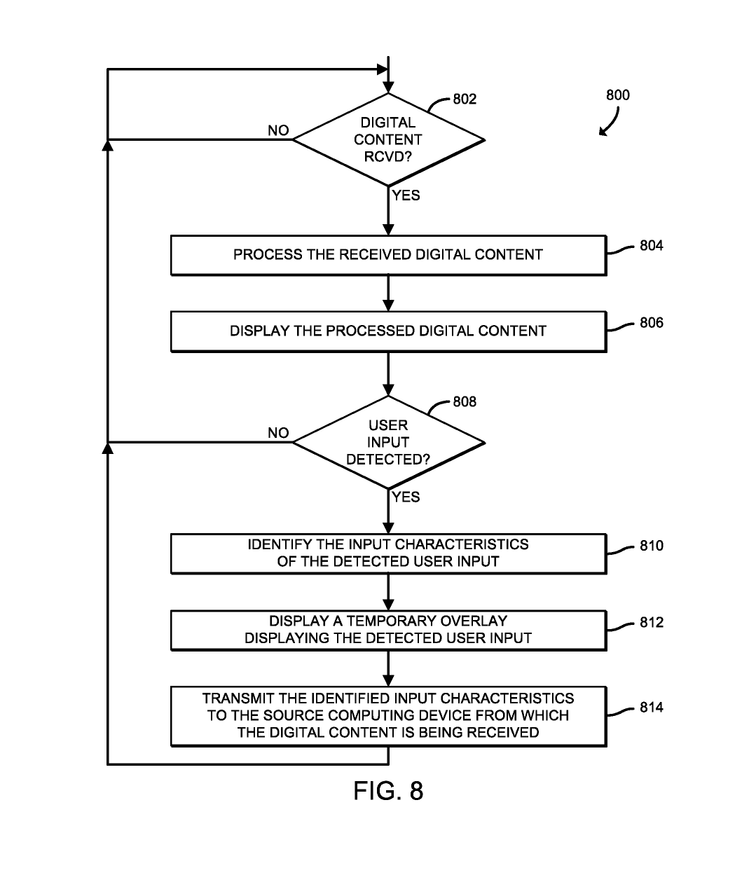

Referring now to FIG. 8, in use, the destination computing device 106 may execute a method 800 for input compute offloading of digital content being transmitted from a source computing device (e.g., the source computing device 106 of FIG. 1). It should be appreciated that a communication channel (e.g., the communication channel 104 of FIG. 1) has been established between the destination computing device 106 and the source computing device 102. It should be further appreciated that at least a portion of the method 800 may be embodied as various instructions stored on a computer-readable media, which may be executed by the processor 130, the GPU 136, the communication circuitry 140 (e.g., the NIC 142), and/or other components of the destination computing device 106 to cause the destination computing device 106 to perform the method 800. The computer-readable media may be embodied as any type of media capable of being read by the destination computing device 106 including, but not limited to, the memory 134, the data storage device 138, a local memory of the NIC 142 (not shown), other memory or data storage devices of the destination computing device 106, portable media readable by a peripheral device of the destination computing device 106, and/or other media.

The method 800 begins in block 802, in which the destination computing device 106 determines whether a network packet that includes digital content (e.g., a frame of digital content) to be rendered by the destination computing device 106 has been received from the source computing device 102. If so, the method 800 advances to block 804, in which the destination computing device 106 processes (e.g., depacketizes, decodes, etc.) the received network packet. In block 806, the destination computing device 106 renders the processed digital content for display to an output device (e.g., one of the peripheral devices 144) of the destination computing device 106. To do so, in some embodiments, the GPU 136 may provide the rendered frame to the output device of the destination computing device 106 for display of video content on a display of the destination computing device 106 or produce audible sound of audio content from a speaker of the destination computing device 106, for example.

In block 808, the destination computing device 106 determines whether any user input has been detected (e.g., via directly touching or using a stylus on a touchscreen display, pressing a key on a keyboard, detecting movement of an element of a mouse, receiving an audible voice command by a microphone, etc.) such that an action (e.g., drawing an object, typing text, etc.) on the digital content being displayed on the destination computing device 106 is expected to be seen on the display of the destination computing device 106. For example, such inputs may be detected via a touch sensor/display and transmitted to the operating system for processing at the processor (e.g., the processor 130 of FIG. 1) or the GPU (e.g., the GPU 136 of FIG. 1) for touch processing. If no user input has been detected, the method 800 returns to block 802 in which the destination computing device 106 determines whether another network packet that includes digital content for output from the destination computing device 106 has been received; otherwise, the method 800 advances to block 810.

In block 810, the destination computing device 106 identifies the input characteristics of the detected user input. In some embodiments, the input characteristics may be identified via a vendor or operating system provided middleware (e.g., Windows Direct Inking framework). Accordingly, the input characteristics supported may be based on the capabilities of the middleware to translate the input into determinable characteristics, such as input coordinates (e.g., screen/display coordinates, output content coordinates, input border coordinates, etc.), input types (e.g., text, shape, etc.), font types, styles, sizes, colors, weights, etc. In such embodiments, the destination computing device 106 stack may program (e.g., through operating system provided hooks) lower level kernel operations (e.g., fast-inking) running on the GPU (e.g., the GPU 136 of FIG. 1) to store the capabilities and/or preferences. In some embodiments, prior to the operating system processing the input, a fast-ink kernel running on the GPU 136 may pass the input data to graphics shaders via a methodology that allows the destination computing device 106 to render the temporary overlay based on the input data. In block 812, the destination computing device 106 displays (i.e., renders and outputs) a temporary overlay displaying a result (e.g., object, text, etc.) of the detected user input and the associated input characteristics.

In block 814, the destination computing device 106 transmits the identified input characteristics to the source computing device 102 from which the digital content is being received (i.e., after the operating system processes the input data). It should be appreciated that, in some embodiments, the destination computing device 106 may continue to render the temporary overlay until it receives an indication from the source computing device 102 indicating the digital content now includes the intended object(s). Additionally or alternatively, in some embodiments, the temporary overlay may timeout, or otherwise only be rendered by the destination computing device 106 for a certain duration of time. For example, in some embodiments, the temporary overlay may be removed after a fixed or variable period of time, such as may be determined subsequent to the source computing device 102 having transmitted the frames that contain input related to the digital content.

### EXAMPLES

Illustrative examples of the technologies disclosed herein are provided below. An embodiment of the technologies may include any one or more, and any combination of, the examples described below.

Example 1 includes a destination computing device for input compute offloading of digital content, the destination computing device comprising a digital content display manager to output digital content received from a wirelessly coupled source computing device to a display of the destination computing device; and an input detector to (i) detect an input by an input device of the destination computing device and (ii) identify one or more input characteristics of the detected input, wherein the input characteristics define information related to the detected input usable to determine an action to be taken subsequent to the input detection, wherein the digital content display manager is further to display, in response to detection of the input, a temporary overlay on the display of the destination computing device based on the detected input; and further comprising a communication manager to transmit the one or more input characteristics to the source computing device, wherein the one or more input characteristics are usable to render the digital content transmitted by the source computing device to include one or more objects based on the one or more input characteristics.

Example 2 includes the subject matter of Example 1, and wherein the digital content comprises a video stream composed of a plurality of captured images of a display of the source computing device, wherein each of the captured images includes a screen capture of at least a portion of the display of the source computing device at the time in which the image was captured.

Example 3 includes the subject matter of any of Examples 1 and 2, and wherein the input characteristics include one or more of a display coordinate, an output content coordinate, an input border coordinate, a text characteristic, a shape characteristic, a font characteristic, or a line characteristic.

Example 4 includes the subject matter of any of Examples 1-3, and wherein to transmit the input characteristics to the source computing device comprises to transmit the input characteristics via an out-of-band communication channel.

Example 5 includes the subject matter of any of Examples 1-4, and further comprising a capability exchange negotiator to (i) exchange input compute offloading capabilities between the source computing device and the destination computing device and (ii) determine which of the exchanged input compute offloading capabilities are to be used during the transmission of the digital content.

Example 6 includes the subject matter of any of Examples 1-5, and wherein to detect the input comprises to detect one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

Example 7 includes the subject matter of any of Examples 1-6, and wherein the action includes outputting one or more objects to the display via the temporary overlay.

Example 8 includes the subject matter of any of Examples 1-7, and wherein the one or more objects includes one or more of a text character, a shape, a line, or a graphic.

Example 9 includes the subject matter of any of Examples 1-8, and wherein the action includes to changing a setting of an application presently executing on the source computing device that corresponds to the digital content received from the source computing device.

Example 10 includes the subject matter of any of Examples 1-9, and wherein the digital content display manager is further to remove the temporary overlay after an elapsed period of time subsequent to the display of the temporary overlay.

Example 11 includes the subject matter of any of Examples 1-10, and wherein the digital content comprises digital content mirrored from the source computing device.

Example 12 includes the subject matter of any of Examples 1-11, and wherein the digital content comprises digital content cast from the source computing device.

Example 13 includes a method for input compute offloading of digital content, the method comprising outputting, by a destination computing device, digital content received from a wirelessly coupled source computing device to a display of the destination computing device; detecting, by the destination computing device, an input by an input device of the destination computing device; identifying, by the destination computing device, one or more input characteristics of the detected input, wherein the input characteristics define information related to the detected input usable to determine an action to be taken subsequent to the input detection; displaying, by the destination computing device and in response to detection of the input, a temporary overlay on the display of the destination computing device based on the detected input; and transmitting, by the destination computing device, the one or more input characteristics to the source computing device, wherein the one or more input characteristics are usable to render the digital content transmitted by the source computing device to include one or more objects based on the one or more input characteristics.

Example 14 includes the subject matter of Example 13, and wherein outputting the digital content comprises outputting a video stream composed of a plurality of captured images of a display of the source computing device, wherein each of the captured images includes a screen capture of at least a portion of the display of the source computing device at the time in which the image was captured.

Example 15 includes the subject matter of any of Examples 13 and 14, and wherein transmitting the input characteristics includes transmitting one or more of a display coordinate, an output content coordinate, an input border coordinate, a text characteristic, a shape characteristic, a font characteristic, or a line characteristic.

Example 16 includes the subject matter of any of Examples 13-15, and wherein transmitting the input characteristics to the source computing device comprises transmitting the input characteristics via an out-of-band communication channel.

Example 17 includes the subject matter of any of Examples 13-16, and comprising: exchanging, by the destination computing device, input compute offloading capabilities between the source computing device and the destination computing device; and determining, by the destination computing device, which of the exchanged input compute offloading capabilities are to be used during the transmission of the digital content.

Example 18 includes the subject matter of any of Examples 13-17, and wherein detecting the input comprises detecting one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

Example 19 includes the subject matter of any of Examples 13-18, and wherein the action includes outputting one or more objects to the display via the temporary overlay.

Example 20 includes the subject matter of any of Examples 13-19, and wherein outputting the one or more objects comprises outputting one or more of a text character, a shape, a line, or a graphic.

Example 21 includes the subject matter of any of Examples 13-20, and wherein the action includes changing a setting of an application presently executing on the source computing device that corresponds to the digital content received from the source computing device.

Example 22 includes the subject matter of any of Examples 13-21, and further comprising removing the temporary overlay subsequent to an elapsed period of time after display of the temporary overlay.

Example 23 includes the subject matter of any of Examples 13-22, and wherein the digital content comprises digital content mirrored from the source computing device.

Example 24 includes the subject matter of any of Examples 13-23, and wherein the digital content comprises digital content cast from the source computing device.

Example 25 includes a destination computing device comprising a processor; and a memory having stored therein a plurality of instructions that when executed by the processor cause the destination computing device to perform the method of any of Examples 13-24.

Example 26 includes one or more machine readable storage media comprising a plurality of instructions stored thereon that in response to being executed result in a destination computing device performing the method of any of Examples 13-24.

Example 27 includes a destination computing device for input compute offloading of digital content, the destination computing device comprising means for outputting digital content received from a wirelessly coupled source computing device to a display of the destination computing device; means for detecting an input by an input device of the destination computing device; means for identifying one or more input characteristics of the detected input, wherein the input characteristics define information related to the detected input usable to determine an action to be taken subsequent to the input detection; means for displaying, in response to detection of the input, a temporary overlay on the display of the destination computing device based on the detected input; and means for transmitting the one or more input characteristics to the source computing device, wherein the one or more input characteristics are usable to render the digital content transmitted by the source computing device to include one or more objects based on the one or more input characteristics.

Example 28 includes the subject matter of Example 27, and wherein the means for outputting the digital content comprises means for outputting a video stream composed of a plurality of captured images of a display of the source computing device, wherein each of the captured images includes a screen capture of at least a portion of the display of the source computing device at the time in which the image was captured.

Example 29 includes the subject matter of any of Examples 27 and 28, and wherein the means for transmitting the input characteristics includes means for transmitting one or more of a display coordinate, an output content coordinate, an input border coordinate, a text characteristic, a shape characteristic, a font characteristic, or a line characteristic.

Example 30 includes the subject matter of any of Examples 27-29, and wherein the means for transmitting the input characteristics to the source computing device comprises means for transmitting the input characteristics via an out-of-band communication channel.

Example 31 includes the subject matter of any of Examples 27-30, and further comprising means for exchanging input compute offloading capabilities between the source computing device and the destination computing device; and means for determining which of the exchanged input compute offloading capabilities are to be used during the transmission of the digital content.

Example 32 includes the subject matter of any of Examples 27-31, and wherein the means for detecting the input comprises means for detecting one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

Example 33 includes the subject matter of any of Examples 27-32, and wherein the action includes means for outputting one or more objects to the display via the temporary overlay.

Example 34 includes the subject matter of any of Examples 27-33, and wherein the means for outputting the one or more objects comprises means for outputting one or more of a text character, a shape, a line, or a graphic.

Example 35 includes the subject matter of any of Examples 27-34, and wherein the action includes means for changing a setting of an application presently executing on the source computing device that corresponds to the digital content received from the source computing device.

Example 36 includes the subject matter of any of Examples 27-35, and further comprising means for removing the temporary overlay subsequent to an elapsed period of time after display of the temporary overlay.

Example 37 includes the subject matter of any of Examples 27-36, and wherein the digital content comprises digital content mirrored from the source computing device.

Example 38 includes the subject matter of any of Examples 27-37, and wherein the digital content comprises digital content cast from the source computing device.

Example 39 includes a source computing device for input compute offloading of digital content, the source computing device comprising a digital content adjustment manager to transmit digital content to a destination computing device wirelessly coupled to the source computing device; a communication manager to receive one or more input characteristics from the destination computing device, wherein the input characteristics define one or more characteristics of an input initiated by a user on a display of the destination computing device; and a digital content adjustment manager to render the digital content to include one or more objects based on the one or more input characteristics.

Example 40 includes the subject matter of Example 39, and wherein the digital content comprises a video stream composed of a plurality of screen capture images of the source computing device, wherein each of the screen capture images includes a screen capture of a display of the source computing device at the time in which the display was captured.

Example 41 includes the subject matter of any of Examples 39 and 40, and wherein the input characteristics include one or more of a display coordinate, an output content coordinate, an input border coordinate, a text characteristic, a shape characteristic, a font characteristic, or a line characteristic.

Example 42 includes the subject matter of any of Examples 39-41, and wherein the input characteristics are received from the destination computing device via an out-of-band communication channel.

Example 43 includes the subject matter of any of Examples 39-42, and further comprising a capability exchange negotiator to (i) exchange input compute offloading capabilities between the source computing device and the destination computing device and (ii) determine which of the exchanged input compute offloading capabilities are to be used during the transmission of the digital content.

Example 44 includes the subject matter of any of Examples 39-43, and wherein the digital content comprises digital content mirrored from the source computing device.

Example 45 includes the subject matter of any of Examples 39-44, and wherein the digital content comprises digital content cast from the source computing device.

Example 46 includes a method for input compute offloading of digital content, the method comprising transmitting, by a source computing device, digital content to a destination computing device wirelessly coupled to the source computing device; receiving, by the source computing device, one or more input characteristics from the destination computing device, wherein the input characteristics define characteristics of an input initiated by a user on a display of the destination computing device; and rendering, by the source computing device, the digital content to include one or more objects based on the one or more input characteristics.

Example 47 includes the subject matter of Example 46, and wherein transmitting the digital content comprises transmitting a video stream composed of a plurality of screen capture images of the source computing device, wherein each of the screen capture images includes a screen capture of a display of the source computing device at the time in which the display was captured.

Example 48 includes the subject matter of any of Examples 46 and 47, and wherein receiving the input characteristics from the destination computing device comprises receiving one or more of a display coordinate, an output content coordinate, an input border coordinate, a text characteristic, a shape characteristic, a font characteristic, or a line characteristic.

Example 49 includes the subject matter of any of Examples 46-48, and wherein receiving the input characteristics from the destination computing device comprises receiving the input characteristics via an out-of-band communication channel.

Example 50 includes the subject matter of any of Examples 46-49, and further comprising exchanging, by the source computing device, input compute offloading capabilities between the source computing device and the destination computing device; and determining, by the source computing device, which of the exchanged input compute offloading capabilities are to be used during the transmission of the digital content.

Example 51 includes the subject matter of any of Examples 46-50, and wherein the digital content comprises digital content mirrored from the source computing device.

Example 52 includes the subject matter of any of Examples 46-51, and wherein the digital content comprises digital content cast from the source computing device.

Example 53 includes a source computing device comprising a processor; and a memory having stored therein a plurality of instructions that when executed by the processor cause the source computing device to perform the method of any of Examples 46-52.

Example 54 includes one or more machine readable storage media comprising a plurality of instructions stored thereon that in response to being executed result in a source computing device performing the method of any of Examples 46-52.

Example 55 includes a source computing device for input compute offloading of digital content, the source computing device comprising means for transmitting digital content to a destination computing device wirelessly coupled to the source computing device; means for receiving one or more input characteristics from the destination computing device, wherein the input characteristics define characteristics of an input initiated by a user on a display of the destination computing device; and means for rendering the digital content to include one or more objects based on the one or more input characteristics.

Example 56 includes the subject matter of Example 55, and wherein the means for transmitting the digital content comprises means for transmitting a video stream composed of a plurality of screen capture images of the source computing device, wherein each of the screen capture images includes a screen capture of a display of the source computing device at the time in which the display was captured.

Example 57 includes the subject matter of any of Examples 55 and 56, and wherein the means for receiving the input characteristics from the destination computing device comprises means for receiving one or more of a display coordinate, an output content coordinate, an input border coordinate, a text characteristic, a shape characteristic, a font characteristic, or a line characteristic.

Example 58 includes the subject matter of any of Examples 55-57, and wherein the means for receiving the input characteristics from the destination computing device comprises means for receiving the input characteristics via an out-of-band communication channel.

Example 59 includes the subject matter of any of Examples 55-58, and further comprising means for exchanging input compute offloading capabilities between the source computing device and the destination computing device; and means for determining which of the exchanged input compute offloading capabilities are to be used during the transmission of the digital content.

Example 60 includes the subject matter of any of Examples 55-59, and wherein the digital content comprises digital content mirrored from the source computing device.

Example 61 includes the subject matter of any of Examples 55-60, and wherein the digital content comprises digital content cast from the source computing device.

1. A destination computing device for input compute offloading of digital content, the destination computing device comprising:
a digital content display manager to output digital content received from a wirelessly coupled source computing device to a display of the destination computing device; and
an input detector to (i) detect an input by an input device of the destination computing device and (ii) identify one or more input characteristics of the detected input, wherein the input characteristics define information related to the detected input usable to determine an action to be taken subsequent to the input detection,
wherein the digital content display manager is further to display, in response to detection of the input, a temporary overlay on the display of the destination computing device based on the detected input; and
further comprising a communication manager to transmit the one or more input characteristics to the source computing device, wherein the one or more input characteristics are usable to render the digital content transmitted by the source computing device to include one or more objects based on the one or more input characteristics.

2. The destination computing device of claim 1, wherein the digital content comprises a video stream composed of a plurality of captured images of a display of the source computing device, wherein each of the captured images includes a screen capture of at least a portion of the display of the source computing device at the time in which the image was captured.

3. The destination computing device of claim 1, wherein the input characteristics include one or more of a display coordinate, an output content coordinate, an input border coordinate, a text characteristic, a shape characteristic, a font characteristic, or a line characteristic.

4. The destination computing device of claim 3, wherein to transmit the input characteristics to the source computing device comprises to transmit the input characteristics via an out-of-band communication channel.

5. The destination computing device of claim 1, wherein to detect the input comprises to detect one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

6. The destination computing device of claim 1, wherein the action includes outputting one or more objects to the display via the temporary overlay.

7. The destination computing device of claim 6, wherein the one or more objects includes one or more of a text character, a shape, a line, or a graphic.

8. The destination computing device of claim 1, wherein the action includes to changing a setting of an application presently executing on the source computing device that corresponds to the digital content received from the source computing device.

9. The destination computing device of claim 1, wherein the temporary overlay is no longer displayed after an elapsed period of time subsequent to the display of the temporary overlay.

10. One or more computer-readable storage media comprising a plurality of instructions stored thereon that in response to being executed cause a destination computing device to:
output digital content received from a wirelessly coupled source computing device to a display of the destination computing device;
detect an input by an input device of the destination computing device;
identify one or more input characteristics of the detected input, wherein the input characteristics define information related to the detected input usable to determine an action to be taken subsequent to the input detection;
display, in response to detection of the input, a temporary overlay on the display of the destination computing device based on the detected input; and
transmit the one or more input characteristics to the source computing device, wherein the one or more input characteristics are usable to render the digital content transmitted by the source computing device to include one or more objects based on the one or more input characteristics.

11. The one or more computer-readable storage media of claim 10, wherein the digital content comprises a video stream composed of a plurality of captured images of a display of the source computing device, wherein each of the captured images includes a screen capture of at least a portion of the display of the source computing device at the time in which the image was captured.

12. The one or more computer-readable storage media of claim 10, wherein the input characteristics include one or more of a display coordinate, an output content coordinate, an input border coordinate, a text characteristic, a shape characteristic, a font characteristic, or a line characteristic.

13. The one or more computer-readable storage media of claim 12, wherein to transmit the input characteristics to the source computing device comprises to transmit the input characteristics via an out-of-band communication channel.

14. The one or more computer-readable storage media of claim 10, wherein to detect the input comprises to detect one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

15. The one or more computer-readable storage media of claim 10, wherein the action includes outputting one or more objects to the display via the temporary overlay.

16. The one or more computer-readable storage media of claim 15, wherein the one or more objects includes one or more of a text character, a shape, a line, or a graphic.

17. The one or more computer-readable storage media of claim 10, wherein the action includes to changing a setting of an application presently executing on the source computing device that corresponds to the digital content received from the source computing device.

18. The one or more computer-readable storage media of claim 10, wherein the plurality of instructions further cause the computing device node to remove the temporary overlay after an elapsed period of time subsequent to the display of the temporary overlay.

19. A method for input compute offloading of digital content, the method comprising:
outputting, by a destination computing device, digital content received from a wirelessly coupled source computing device to a display of the destination computing device;
detecting, by the destination computing device, an input by an input device of the destination computing device;
identifying, by the destination computing device, one or more input characteristics of the detected input, wherein the input characteristics define information related to the detected input usable to determine an action to be taken subsequent to the input detection;
displaying, by the destination computing device and in response to detection of the input, a temporary overlay on the display of the destination computing device based on the detected input; and
transmitting, by the destination computing device, the one or more input characteristics to the source computing device,
wherein the one or more input characteristics are usable to render the digital content transmitted by the source computing device to include one or more objects based on the one or more input characteristics.

20. The method of claim 19, wherein outputting the digital content comprises outputting a video stream composed of a plurality of captured images of a display of the source computing device, wherein each of the captured images includes a screen capture of at least a portion of the display of the source computing device at the time in which the image was captured.

21. The method of claim 19, wherein transmitting the input characteristics includes transmitting one or more of a display coordinate, an output content coordinate, an input border coordinate, a text characteristic, a shape characteristic, a font characteristic, or a line characteristic.

22. The method of claim 19, wherein transmitting the input characteristics to the source computing device comprises transmitting the input characteristics via an out-of-band communication channel.

23. The method of claim 19, wherein detecting the input comprises detecting one of a finger movement on a touchscreen display of the destination computing device, a stylus movement on the touchscreen display, a key press on a keyboard of the destination computing device, a movement of an element of a mouse of the destination computing device, or an audible voice command by a microphone of the destination computing device.

24. The method of claim 19, wherein the action includes outputting one or more objects to the display via the temporary overlay.

25. The method of claim 19, wherein the action includes changing a setting of an application presently executing on the source computing device that corresponds to the digital content received from the source computing device.
